(19) United States
(12) Patent Application Publication
(10) Pub. No.: US 2025/0378986 A1
(43) Pub. Date: Dec. 11, 2025

(54) INTEGRATED PLANAR TRANSFORMER WITH HORIZONTALLY-ALIGNED AIR GAPS AND METHOD

(71) Applicant: Raytheon Company, Tewksbury, MA (US)

(72) Inventors: Jeffrey Ewanchuk, Manchester, CT (US); Warren W. Chen, Glastonbury, CT (US); Suman Dwari, Vernon, CT (US); Sriram Chandrasekaran, Lucas, TX (US)

(21) Appl. No.: 18/739,150

(22) Filed: Jun. 10, 2024

(51) Int. Cl. H01F 27/28; H01F 27/24; H01F 27/29; H01F 41/02

(52) U.S. Cl. CPC H01F 27/2804; H01F 27/24; H01F 27/29; H01F 41/0206

(57) ABSTRACT

An integrated planar transformer includes a main magnetic core body and a pair of side magnetic core structures. The main magnetic core body includes a transformer segment and an inductor segment. The pair of side magnetic core structures is coupled to opposing sides of the inductor segment. Each of the side magnetic core structures is configured to form a horizontally-aligned air gap for the integrated planar transformer. Each of the side magnetic core structures may be configured to form the horizontally-aligned air gap for the integrated planar transformer between the side magnetic core structure and the inductor segment. The integrated planar transformer may further include at least one pair of dividers coupled to the opposing sides of the inductor segment, where each of the dividers is configured to form an additional horizontally-aligned air gap for the integrated planar transformer. Each of the dividers may be configured to form the additional horizontally-aligned air gap between the inductor segment and the divider.

### TECHNICAL FIELD

This disclosure relates generally to integrated transformers and inductors. More specifically, this disclosure relates to an integrated planar transformer with horizontally-aligned air gaps and method.

### BACKGROUND

Radio frequency (RF) power systems can feature multiple power converters and are under increased pressure to decrease their size, weight, and power (SWAP). Direct current (DC)/DC soft-switched converters typically use discrete inductors external to the isolation transformers to achieve high efficiency and power density. However, conventional discrete resonant inductors require board area due to their terminations and are further constrained by high-voltage spacing requirements that limit the power density on printed circuit boards (PCBs) or substrates.

### SUMMARY

This disclosure relates to an integrated planar transformer with horizontally-aligned air gaps and method.

In a first embodiment, an integrated planar transformer includes a main magnetic core body and a pair of side magnetic core structures. The main magnetic core body includes a transformer segment and an inductor segment. The pair of side magnetic core structures is coupled to opposing sides of the inductor segment. Each of the side magnetic core structures is configured to form a horizontally-aligned air gap for the integrated planar transformer.

In a second embodiment, an integrated planar transformer includes a main magnetic core body, a first side magnetic core structure, and a second side magnetic core structure. The main magnetic core body includes a transformer segment and an inductor segment. The first side magnetic core structure is coupled to a left side of the inductor segment. The first side magnetic core structure is configured to form a first horizontally-aligned air gap for the integrated planar transformer. The second side magnetic core structure is coupled to a right side of the inductor segment. The second side magnetic core structure is configured to form a second horizontally-aligned air gap for the integrated planar transformer.

In a third embodiment, a method includes coupling a first side magnetic core structure to a main magnetic core body for an integrated planar transformer to form a first horizontally-aligned air gap between the first side magnetic core structure and the main magnetic core body. The method also includes coupling a second side magnetic core structure to the main magnetic core body for the integrated planar transformer to form a second horizontally-aligned air gap between the second side magnetic core structure and the main magnetic core body.

Other technical features may be readily apparent to one skilled in the art from the following figures, descriptions, and claims.

### BRIEF DESCRIPTION OF THE DRAWINGS

For a more complete understanding of this disclosure, reference is made to the following description, taken in conjunction with the accompanying drawings, in which:

FIG. 1 illustrates an example of a top or bottom core half of an integrated planar transformer according to this disclosure;

FIG. 2 illustrates an example of a portion of the integrated planar transformer of FIG. 1 according to this disclosure;

FIGS. 3A-C illustrate schematic diagrams of the fabrication of an integrated planar transformer according to this disclosure;

FIG. 4 illustrates a side view of the integrated planar transformer of FIGS. 3A-C according to this disclosure;

FIG. 5 illustrates a bottom view of a portion of the integrated planar transformer of FIGS. 3A-C according to this disclosure;

FIGS. 6A-D illustrate schematic diagrams of primary winding printed wiring boards of an integrated planar transformer according to this disclosure; and

FIG. 7 illustrates an example of a method for forming an integrated planar transformer according to this disclosure.

### DETAILED DESCRIPTION

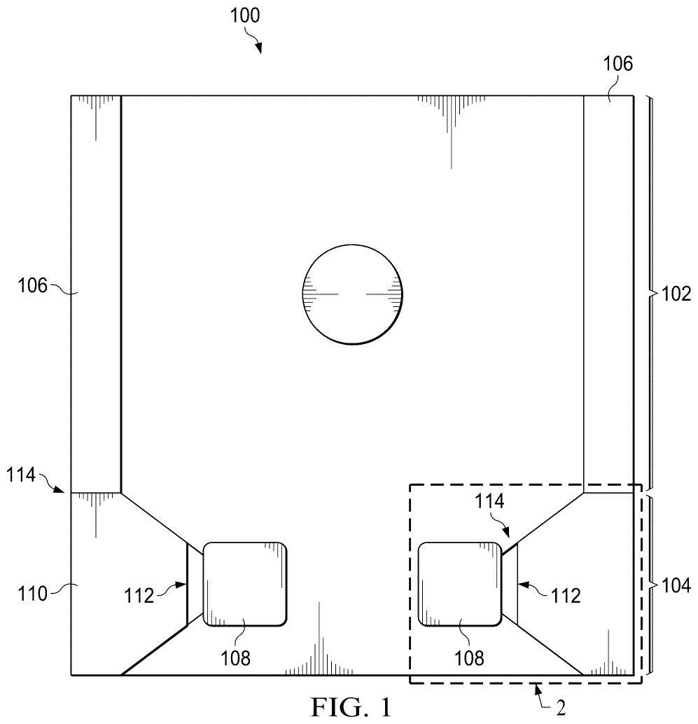

FIGS. 1 through 7, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, radio frequency (RF) power systems can feature multiple power converters and are under increased pressure to decrease their size, weight, and power (SWAP). Direct current (DC)/DC soft-switched converters typically use discrete inductors external to the isolation transformers to achieve high efficiency and power density. However, conventional discrete resonant inductors use individual termination and are constrained by high-voltage spacing requirements that limit the power density due to dissimilar footprints on printed circuit boards (PCBs) or substrates. In addition, high step-down DC/DC converters typically require large resonant inductors in series with transformers to achieve high conversion efficiencies. Because these resonant inductors can be bulky, integration with the transformer offers the potential for size reduction. However, certain conventional integration approaches, such as using common windings across the magnetic core, can suffer from poor conduction losses due to the orientation of the inductor windings relative to the vertical air gaps present in the inductor segment.

This disclosure provides an integrated planar transformer with horizontally-aligned air gaps that results in a substantial reduction in copper losses in an inductor segment of the integrated assembly. In this way, the total alternating current (AC) resistance of the inductor windings may be reduced by about 50% in some cases. In addition, the air gaps of the disclosed integrated planar transformer are naturally aligned during fabrication instead of requiring precise insertion of a T-shape component that would need to be exactly centered to provide equally aligned air gaps. Integration of horizontally-aligned air gaps in the disclosed planar structure also improves the window utilization factor, allowing more copper per area as compared with integrated transformers that implement vertical air gaps due to having to avoid the fringing magnetic field produced from the latter air gaps.

FIG. 1 illustrates an example of a top or bottom core half 100 of an integrated planar transformer according to this disclosure. The embodiment of the core half 100 of the integrated planar transformer shown in FIG. 1 is for illustration only. Other embodiments of the core half 100 of the integrated planar transformer could be used without departing from the scope of this disclosure.

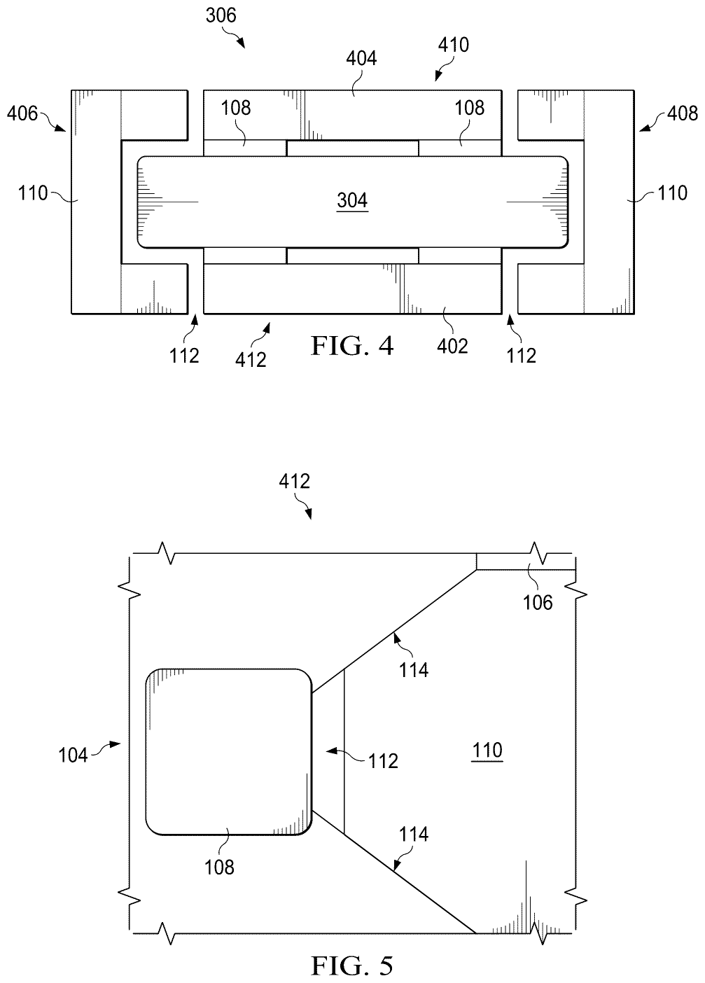

According to embodiments of this disclosure, the core half 100 of the integrated planar transformer includes a transformer segment 102 and an inductor segment 104. The transformer segment 102 includes a pair of transformer posts 106, and the inductor segment 104 includes a pair of inductor posts 108. The inductor segment 104 also includes a pair of side magnetic core structures 110. Each of the side magnetic core structures 110 is configured to be milled separately from the main magnetic core body of the core half 100 and to be coupled to opposing sides of the inductor segment 104 such that a horizontally-aligned air gap 112 is formed between the side magnetic core structure 110 and its corresponding inductor post 108. As described in more detail below in connection with FIG. 4, as used herein, a “horizontally-aligned air gap” is an air gap formed between components of the integrated planar transformer in a horizontal direction as opposed to a vertical direction.

For some embodiments, the core half 100 may include a ferrite piece that is milled with the transformer segment 102 formed in a conventional transformer core shape, such as an ER or other suitable core shape, and the inductor segment 104 including two inductor posts 108 without a closed shell. The side magnetic core structures 110 may include two C-shaped ferrite pieces milled with a radius based on a combination of the separation distance between the inductor posts 108 and the desired widths of the horizontally-aligned air gaps 112. For some embodiments, the side magnetic core structures 110 may be coupled to the main magnetic core body of the core half 100 with an adhesive 114. The adhesive 114 can include a conductive epoxy or other suitable bonding material. The thickness of the layer of adhesive 114 further adds to the effective widths of the horizontally-aligned air gaps 112.

Although FIG. 1 illustrates one example of a core half 100 of an integrated planar transformer with horizontally-aligned air gaps 112, various changes may be made to FIG. 1. For instance, the core half 100 of the integrated planar transformer may include additional components not shown in FIG. 1. Also, note that the view shown in FIG. 1 is not to scale.

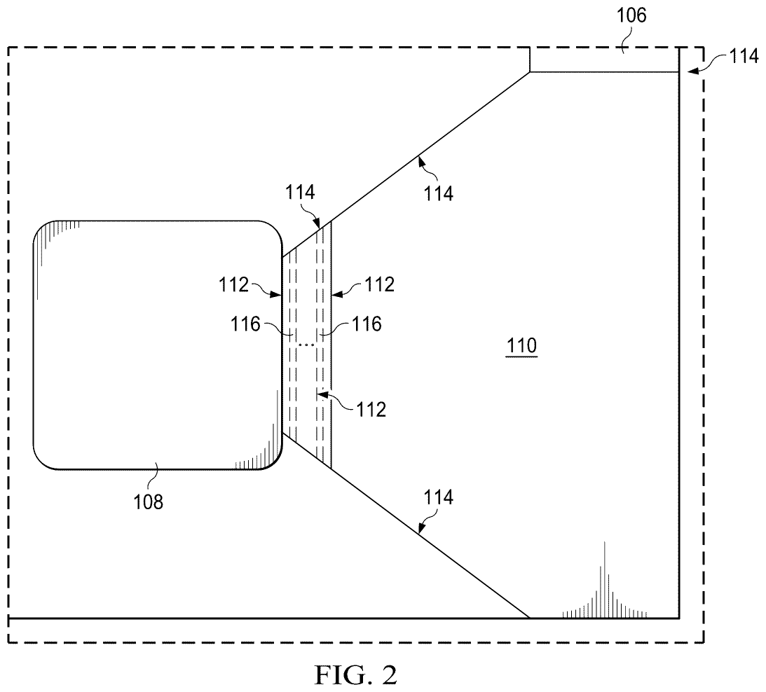

FIG. 2 illustrates an example of a portion of the core half 100 of the integrated planar transformer of FIG. 1 according to this disclosure. The embodiment of the core half 100 of the integrated planar transformer shown in FIG. 2 is for illustration only. Other embodiments of the core half 100 of the integrated planar transformer could be used without departing from the scope of this disclosure.

According to embodiments of this disclosure, the core half 100 may optionally include one or more dividers 116 for each inductor post 108. Each divider 116 included in the core half 100 may be coupled to the main magnetic core body of the core half 100 either with the same adhesive 114 used to couple the side magnetic core structures 110 to the core half 100 or with any other suitable adhesive. Thus, the adhesive 114 coupling the dividers 116 to the main magnetic core body of the core half 100 can include a conductive epoxy or other suitable bonding material.

Each divider 116 is configured to separate the horizontally-aligned air gap 112 into multiple horizontally-aligned air gaps 112. For example, for the illustrated embodiment, two dividers 116 are configured to separate the space between the inductor post 108 and the side magnetic core structure 110 into three horizontally-aligned air gaps 112. Thus, for each divider 116 included in the core half 100, an additional horizontally-aligned air gap 112 is formed. In this way, depending on the application and/or the desired operating conditions, the integrated planar transformer may be formed with any suitable number of horizontally-aligned air gaps 112.

Although FIG. 2 illustrates examples of a portion of the core half 100 of the integrated planar transformer, various changes may be made to FIG. 2. For instance, the core half 100 of the integrated planar transformer may include any suitable number of dividers 116 to provide for any suitable number of additional horizontal air gaps 112. Also, note that the view shown in FIG. 2 is not to scale.

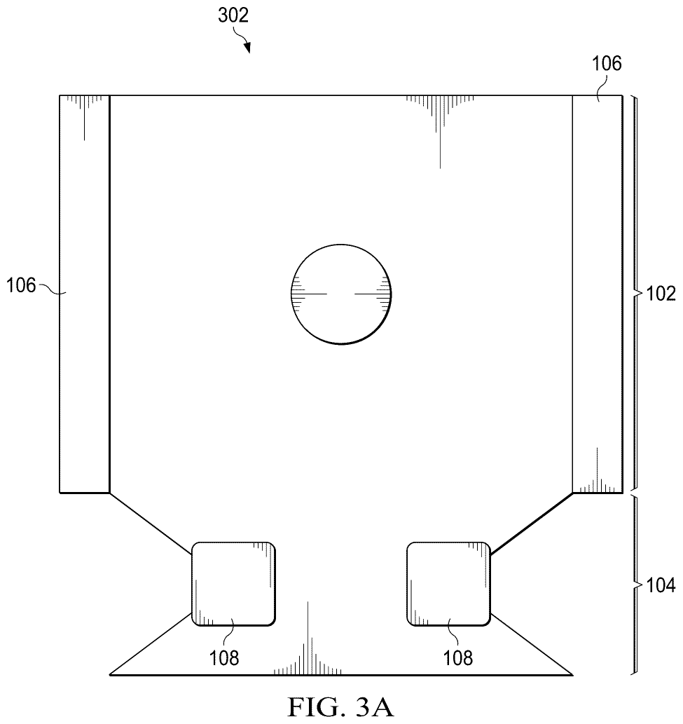

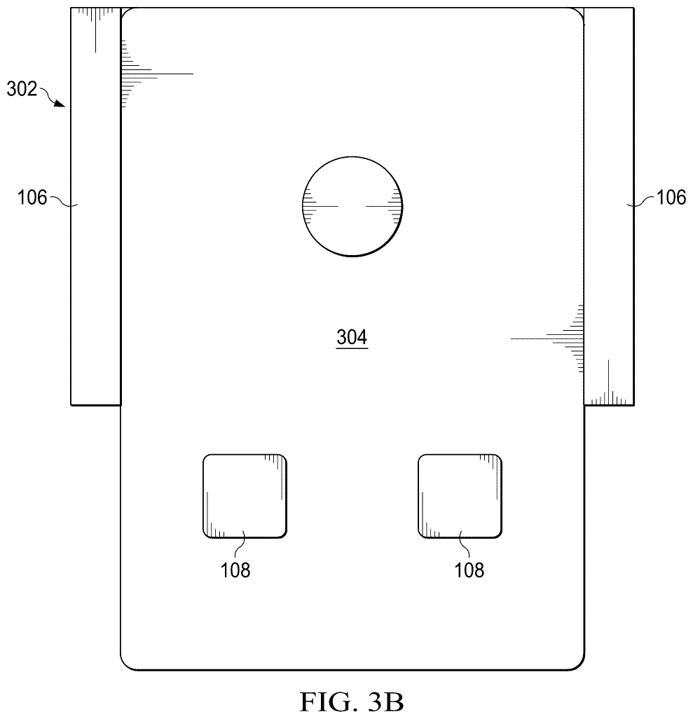

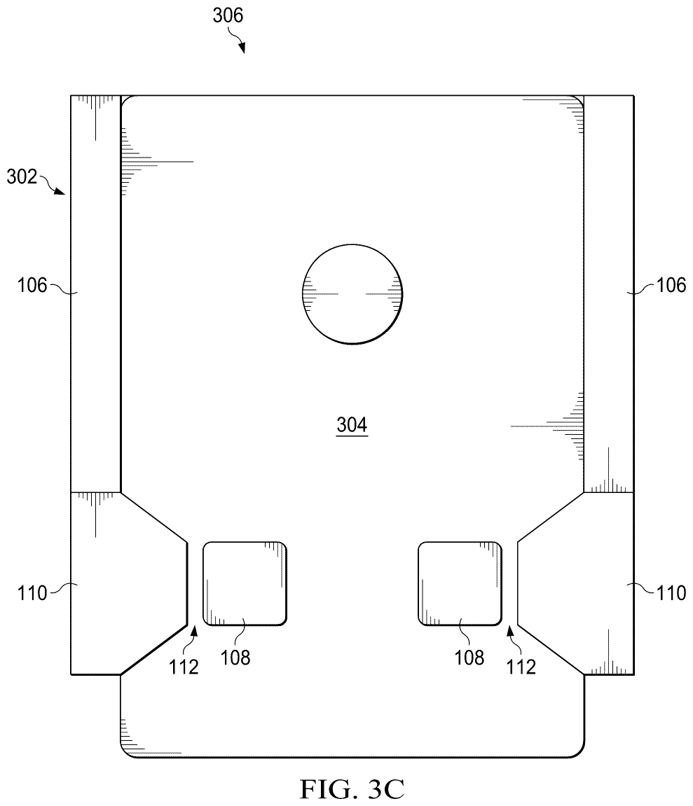

FIGS. 3A-C illustrate schematic diagrams of the fabrication of an integrated planar transformer according to this disclosure. The embodiment of the integrated planar transformer shown in FIGS. 3A-C is for illustration only. Other embodiments of the integrated planar transformer could be used without departing from the scope of this disclosure.

According to embodiments of this disclosure, as shown in FIG. 3A, a main magnetic core body 302 of the integrated planar transformer is milled in the shape of the integrated planar transformer, including the transformer segment 102 and the inductor segment 104. The main magnetic core body 302 includes the transformer posts 106 and the inductor posts 108, as described in more detail above in connection with FIG. 1. For some embodiments, the main magnetic core body 302 may include a ferrite piece that is milled with the transformer segment 102 formed in a conventional transformer core shape, such as an ER or other suitable core shape, and the inductor segment 104 including two inductor posts 108 without a closed shell.

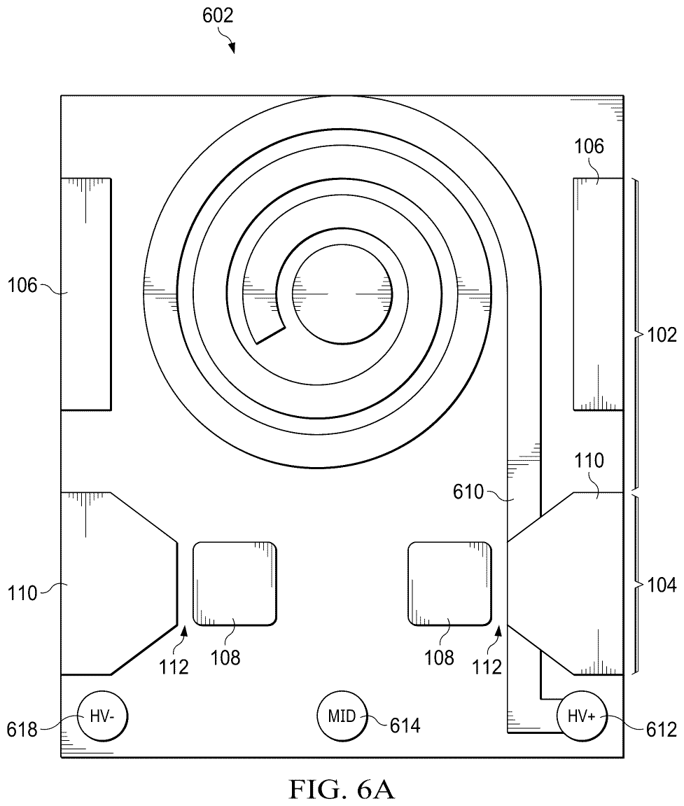

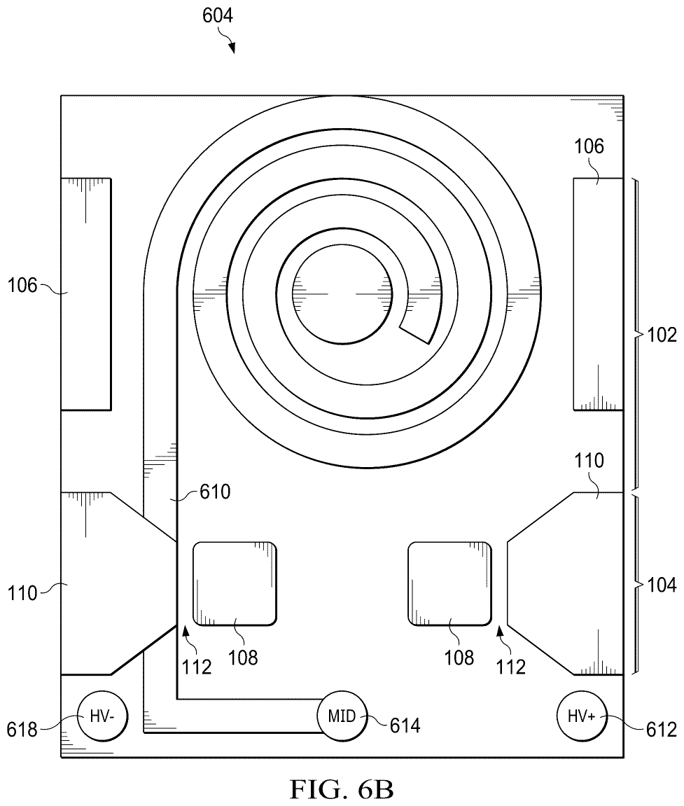

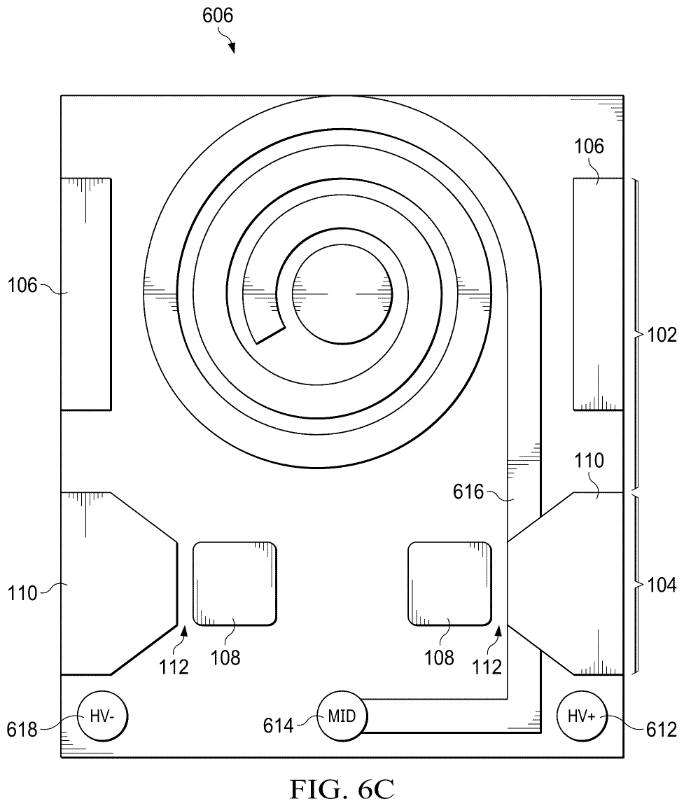

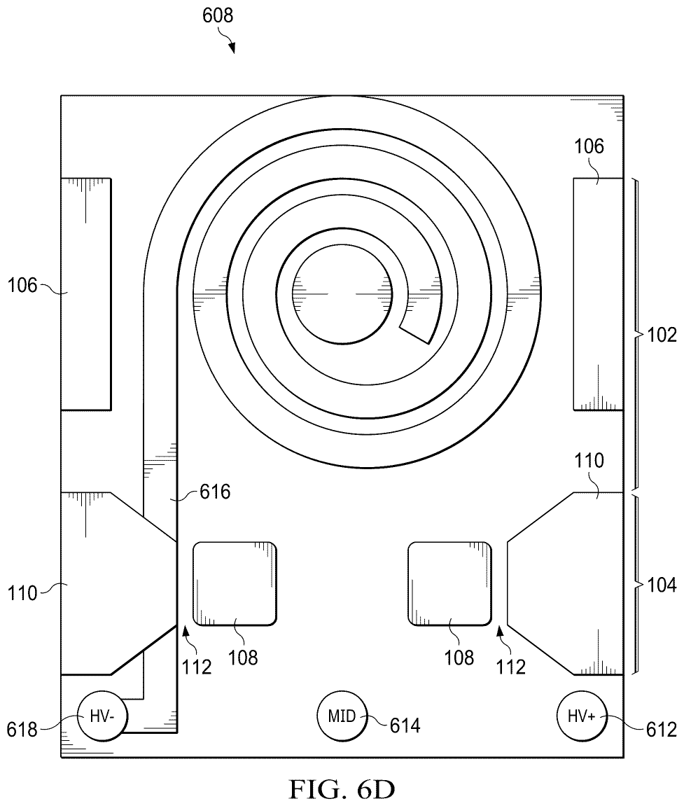

As shown in FIG. 3B, a printed wiring board (PWB) 304 is installed onto the main magnetic core body 302. The PWB 304 includes common windings of the integrated planar transformer and inductor, as described in more detail below in connection with FIGS. 6A-D. Although illustrated and described as including a printed wiring board 304, it will be understood that the integrated planar transformer 306 can include other suitable windings or coils technologies, such as pre-wound coil, pre-formed coils or the like. As shown in FIG. 3C, the side magnetic core structures 110 are coupled to opposing sides of the inductor segment 104 of the main magnetic core body 302, after which a top core (not shown in FIG. 3C) may be installed over the PWB 304 to complete the formation of the integrated planar transformer 306. Thus, in this way, horizontally-aligned air gaps 112 may be formed in the integrated planar transformer 306, thereby providing a substantial reduction in copper losses in the inductor segment 104 of the integrated planar transformer 306. In addition, the horizontally-aligned air gaps 112 of the integrated planar transformer 306 are naturally aligned during fabrication instead of requiring precise insertion of a T-shape component that would need to be exactly centered to provide equally aligned air gaps. Also, the window utilization factor is improved, allowing more copper per area as compared with an integrated transformer that implements vertical air gaps as the magnetic fringing fields from these gaps are moved in location.

Although FIGS. 3A-C illustrate one example of the fabrication of an integrated planar transformer 306 with horizontally-aligned air gaps 112, various changes may be made to FIGS. 3A-C. For instance, as described in more detail above in connection with FIG. 2, fabrication of the integrated planar transformer 306 may include installation of any suitable number of dividers 116 coupled to the main magnetic core body 302 before the side magnetic core structures 110 are installed in order to form additional horizontally-aligned gaps 112 in the integrated planar transformer 306. In addition, the integrated planar transformer 306 may include additional components not shown in FIGS. 3A-C. Also, note that the views shown in FIGS. 3A-C are not to scale.

FIG. 4 illustrates a side view of the integrated planar transformer 306 of FIGS. 3A-C according to this disclosure. The embodiment of the integrated planar transformer 306 shown in FIG. 4 is for illustration only. Other embodiments of the integrated planar transformer 306 could be used without departing from the scope of this disclosure.

According to embodiments of this disclosure, the inductor posts 108 are formed over a bottom core 402 of the main magnetic core body 302. In addition, a top core 404 is installed over the PWB 304. As described in more detail above in connection with FIG. 1, the side magnetic core structures 110 form horizontally-aligned air gaps 112 within the integrated planar transformer 306. The air gaps 112 are “horizontally-aligned” in that they are formed between components of the integrated planar transformer 306 in a horizontal direction as opposed to a vertical direction. Thus, for the illustrated embodiment, each horizontally-aligned air gap 112 is formed between a side magnetic core structure 110 and the main magnetic core body 302 in a left/right direction, such as where the horizontally-aligned air gap 112 is provided between a left side 406 of the integrated planar transformer 306 and a right side 408 of the integrated planar transformer 306. Alternatively, if a vertically-aligned air gap were included, the vertically-aligned air gap would be formed between components of the integrated planar transformer 306 in a top/bottom direction, such as where the air gap would be provided between an upper side 410 of the integrated planar transformer 306 and a lower side 412 of the integrated planar transformer 306.

Although FIG. 4 illustrates one example of a side view of an integrated planar transformer 306 with horizontally-aligned air gaps 112, various changes may be made to FIG. 4. For instance, as described in more detail above in connection with FIG. 2, the integrated planar transformer 306 may include any suitable number of dividers 116 to form additional horizontally-aligned air gaps 112. Also, note that the view shown in FIG. 4 is not to scale.

FIG. 5 illustrates a bottom view of a portion of the integrated planar transformer 306 of FIGS. 3A-C according to this disclosure. Thus, the portion illustrated in FIG. 5 provides a view from the lower side 412 of the integrated planar transformer 306. The embodiment of the integrated planar transformer 306 shown in FIG. 5 is for illustration only. Other embodiments of the integrated planar transformer 306 could be used without departing from the scope of this disclosure.

According to embodiments of this disclosure, as described in more detail above in connection with FIG. 1, a side magnetic core structure 110 may be coupled to the inductor segment 104 of the integrated planar transformer 306 with an adhesive 114 to form a horizontally-aligned air gap 112 between an inductor post 108 and the side magnetic core structure 110. The adhesive 114 coupling the side magnetic core structure 110 to the inductor segment 104 can include a conductive epoxy or other suitable bonding material. The thickness of the layer of adhesive 114 further adds to the effective width of the horizontally-aligned air gap 112.

Although FIG. 5 illustrates one example of a portion of an integrated planar transformer 306 with horizontally-aligned air gaps 112, various changes may be made to FIG. 5. For instance, as described in more detail above in connection with FIG. 2, the integrated planar transformer 306 may include any suitable number of dividers 116 to form additional horizontally-aligned air gaps 112. Also, note that the view shown in FIG. 5 is not to scale.

FIGS. 6A-D illustrate schematic diagrams of primary winding printed wiring boards (PWBs) of an integrated planar transformer 306 according to this disclosure. The embodiment of the primary winding PWBs of the integrated planar transformer 306 shown in FIGS. 6A-D is for illustration only. Other embodiments of the primary winding PWBs of the integrated planar transformer 306 could be used without departing from the scope of this disclosure.

According to embodiments of this disclosure, the integrated planar transformer 306 includes at least two multi-layer primary winding PWBs. It will be understood that additional primary winding PWBs may also be included (not shown in FIGS. 6A-D). For the illustrated embodiment, a first primary winding PWB shown in FIGS. 6A-B includes a first layer 602 and a second layer 604, and a second primary winding PWB shown in FIGS. 6C-D includes a first layer 606 and a second layer 608. These layers form series-connected turns with an electrical via providing the connection between layers.

On the first layer 602 of the first primary winding PWB, a winding 610 is provided from a positive high voltage (HV+) post 612 through the inductor segment 104 and around the transformer segment 102. On the second layer 604, the winding 610 unwinds around the transformer segment 102, comes through the inductor segment 104 and is coupled to a middle voltage (MID) post 614. The middle voltage post 614 is configured to couple the winding 610 from the first primary winding PWB to the second primary winding PWB.

On the first layer 606 of the second primary winding PWB, a winding 616 is provided from the middle voltage post 614 through the inductor segment 104 and around the transformer segment 102. On the second layer 608, the winding 616 unwinds around the transformer segment 102, comes through the inductor segment 104 and is coupled to a negative high voltage (HV−) post 618. In this way, multiple series windings may be integrated with multiple turns on the inductor segment 104 without requiring physical turns on the inductor segment 104.

For this embodiment, the flux for the transformer returns to the transformer segment 102 without interacting with the inductor. Similarly, the flux for the inductor returns to the inductor segment 104 without interacting with the transformer. The flux path for the inductor is through each inductor post 108 and its corresponding side magnetic core structure 110 due to the magnetization of the core 100 resulting in this flux path being of lower reluctance as compared to a path through the base of the integrated planar transformer 306. Thus, the integrated planar transformer 306 provides shared windings for the transformer and inductor, but the flux is not shared between the transformer and the inductor. In this way, the inductor and transformer segments can be independently designed without additional complexity.

Although FIGS. 6A-D illustrate one example of primary winding PWBs of an integrated planar transformer 306 with horizontally-aligned air gaps 112, various changes may be made to FIG. 6A-D. For instance, the integrated planar transformer 306 may include additional components not shown in FIGS. 6A-D. For example, for a particular embodiment, the integrated planar transformer 306 may include four multi-layer primary winding PWBs or any other suitable number of primary winding PWBs. Also, note that the views shown in FIGS. 6A-D are not to scale. In addition, it will be understood that the integrated planar transformer 306 includes secondary windings (not shown in FIGS. 6A-D). Finally, although illustrated and described as printed wiring boards, it will be understood that the primary winding PWBs can include other suitable windings or coils technologies, such as pre-wound coil, pre-formed coils or the like.

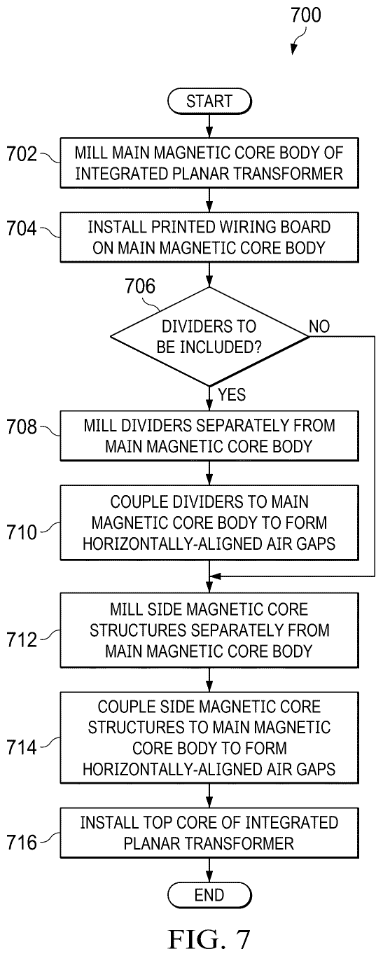

FIG. 7 illustrates an example of a method 700 for forming an integrated planar transformer 306 according to this disclosure. As shown in FIG. 7, a main magnetic core body 302 of the integrated planar transformer 306 is milled at step 702. This may include, for example, milling a ferrite piece into the main magnetic core body 302, with a transformer segment 102 of the main magnetic core body 302 having a conventional transformer core shape, such as an ER or other suitable core shape, and an inductor segment 104 of the main magnetic core body 302 including two inductor posts 108 without a closed shell.

A printed wiring board (PWB) 304 is installed on the main magnetic core body 302 at step 704. The PWB 304 may include, for example, at least two multi-layer primary winding PWBs. As noted above, in some cases, the PWB 304 can include four multi-layer primary winding PWBs. For a particular embodiment, a first primary winding PWB includes a first layer 602 and a second layer 604, and a second primary winding PWB includes a first layer 606 and a second layer 608. On the first layer 602 of the first primary winding PWB, a winding 610 is provided from a positive high voltage (HV+) post 612 through the inductor segment 104 and around the transformer segment 102. On the second layer 604, the winding 610 unwinds around the transformer segment 102, comes through the inductor segment 104 and is coupled to a middle voltage (MID) post 614. The middle voltage post 614 is configured to couple the winding 610 from the first primary winding PWB to the second primary winding PWB.

On the first layer 606 of the second primary winding PWB, a winding 616 is provided from the middle voltage post 614 through the inductor segment 104 and around the transformer segment 102. On the second layer 608, the winding 616 unwinds around the transformer segment 102, comes through the inductor segment 104 and is coupled to a negative high voltage (HV−) post 618. In this way, multiple series windings may be integrated with multiple turns on the inductor segment 104 without requiring physical turns on the inductor segment 104. In addition, this allows the inductor segment 104 to be integrated into the integrated planar transformer with common windings. Also, this allows the transformer segment 102 to be separate from the inductor segment 104 in the core half 100, thereby reducing core losses due to a lack of combined flux within the integrated planar transformer 306.

For embodiments in which dividers 116 are to be included at step 706, a divider 116 is milled for each additional horizontally-aligned air gap 112 to be included at step 708. Each divider 116 is milled separately from the main magnetic core body 302 of the integrated planar transformer 306. This may include, for example, milling a ferrite piece into the shape of a divider 116. As noted above, any suitable number of dividers 116 may be included in the integrated planar transformer 306. For embodiments in which only one horizontally-aligned air gap 112 is to be included and, thus, no dividers 116 are to be included at step 706, the method continues to step 712, as described below.

Each divider 116 to be included is coupled to the main magnetic core body 302 to form a horizontally-aligned air gap 112 at step 710. This may include, for example, coupling the divider 116 to the inductor segment 104 of the main magnetic core body using an adhesive 114. As noted above, in some cases, the adhesive 114 can include a conductive epoxy or other suitable bonding material. A first divider 116 may be coupled to the main magnetic core body 302 to form a horizontally-aligned air gap 112 between an inductor post 108 and the divider 116. Any additional dividers 116 to be included may be coupled to the main magnetic core body 302 to form a horizontally-aligned air gap 112 between the previous divider 116 and the additional divider 116.

Side magnetic core structures 110 are milled separately from the main magnetic core body 302 of the integrated planar transformer 306 at step 712. This may include, for example, milling two C-shaped ferrite cores. As noted above, the two C-shaped ferrite cores may be milled with a radius based on a combination of the separation distance between the inductor posts 108 and the desired widths of the horizontally-aligned air gaps 112.

Each side magnetic core structure 110 is coupled to the main magnetic core body 302 to form a horizontally-aligned air gap 112 at step 714. This may include, for example, coupling the side magnetic core structures 110 to the inductor segment 104 of the main magnetic core body using an adhesive 114. As noted above, in some cases, the adhesive 114 can include a conductive epoxy or other suitable bonding material. The thickness of the layer of adhesive 114 further adds to the effective widths of the horizontally-aligned air gaps 112. The side magnetic core structure 110 may be configured to form a horizontally-aligned air gap 112 between the inductor post 108 and the side magnetic core structure 110 when no dividers 116 are included at step 706 or may be configured to form a horizontally-aligned air gap 112 between the final installed divider 116 and the side magnetic core structure 110 when dividers 116 are included at step 706.

A top core 404 is installed over the bottom core 402 and the PWB 304 at step 716, completing the assembly of the integrated planar transformer 306. This may include, for example, installing a top core 404 milled from a ferrite piece over the bottom core 402.

In this way, the integrated planar transformer 306 may be formed with horizontally-aligned air gaps 112 that are naturally aligned by the fabrication method 700, without requiring precise insertion of a T-shape component that would need to be exactly centered to provide equally aligned air gaps. Including these horizontally-aligned air gaps 112 in the integrated planar transformer 306 improves the window utilization factor, allowing more copper per area as compared with integrated transformers that implement vertical air gaps. In addition, the horizontally-aligned air gaps 112 provide a substantial reduction in copper losses in the inductor segment 104 of the integrated planar transformer 306. By using this method 700, the total AC resistance of the inductor windings may be reduced by about 50%.

Although FIG. 7 illustrates one example of a method 700 for forming an integrated planar transformer 306, various changes may be made to FIG. 7. For example, while shown as a series of steps, various steps in FIG. 7 may overlap, occur in parallel, occur in a different order, or occur any number of times (including zero times). Also, the printed wiring board 304 can include other suitable windings or coils technologies, such as pre-wound coil, pre-formed coils or the like.

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112 (f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112 (f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An integrated planar transformer comprising:
a main magnetic core body comprising a transformer segment and an inductor segment; and
a pair of side magnetic core structures coupled to opposing sides of the inductor segment, wherein each of the side magnetic core structures is configured to form a horizontally-aligned air gap for the integrated planar transformer.

2. The integrated planar transformer of claim 1, wherein each of the side magnetic core structures is configured to form the horizontally-aligned air gap for the integrated planar transformer between the side magnetic core structure and the inductor segment.

3. The integrated planar transformer of claim 1, further comprising:
at least one pair of dividers coupled to the opposing sides of the inductor segment, wherein each of the dividers is configured to form an additional horizontally-aligned air gap for the integrated planar transformer.

4. The integrated planar transformer of claim 3, wherein each of the dividers is configured to form the additional horizontally-aligned air gap between the inductor segment and the divider.

5. The integrated planar transformer of claim 1, further comprising:
a printed wiring board (PWB) installed over the main magnetic core body, wherein the PWB comprises at least two multi-layer primary winding PWBs forming a series-connected turn.

6. The integrated planar transformer of claim 5, wherein the at least two multi-layer primary winding PWBs comprise:
a first primary winding PWB comprising a first layer and a second layer, wherein the first layer of the first primary winding PWB comprises a first winding from a positive high voltage post, through the inductor segment, and around the transformer segment, and wherein the second layer of the first primary winding PWB comprises the first winding unwinding around the transformer segment, passing through the inductor segment, and terminating at a middle voltage post; and
a second primary winding PWB comprising a first layer and a second layer, wherein the first layer of the second primary winding PWB comprises a second winding from the middle voltage post, through the inductor segment, and around the transformer segment, and wherein the second layer of the second primary winding PWB comprises the second winding unwinding around the transformer segment, passing through the inductor segment, and terminating at a negative high voltage post.

7. The integrated planar transformer of claim 1, wherein:
the main magnetic core body comprises ferrite; and
each of the side magnetic core structures comprises ferrite.

8. The integrated planar transformer of claim 1, wherein the pair of side magnetic core structures is coupled to the opposing sides of the inductor segment using a conductive epoxy.

9. An integrated planar transformer comprising:
a main magnetic core body comprising a transformer segment and an inductor segment;
a first side magnetic core structure coupled to a left side of the inductor segment, wherein the first side magnetic core structure is configured to form a first horizontally-aligned air gap for the integrated planar transformer; and
a second side magnetic core structure coupled to a right side of the inductor segment, wherein the second side magnetic core structure is configured to form a second horizontally-aligned air gap for the integrated planar transformer.

10. The integrated planar transformer of claim 9, wherein:
the inductor segment comprises a first inductor post and a second inductor post;
the first side magnetic core structure is configured to form the first horizontally-aligned air gap for the integrated planar transformer between the first inductor post and the first side magnetic core structure; and
the second side magnetic core structure is configured to form the second horizontally-aligned air gap for the integrated planar transformer between the second inductor post and the second side magnetic core structure.

11. The integrated planar transformer of claim 9, further comprising:
a first divider coupled to the left side of the inductor segment, wherein the first divider is configured to form a third horizontally-aligned air gap for the integrated planar transformer; and
a second divider coupled to the right side of the inductor segment, wherein the second divider is configured to form a fourth horizontally-aligned air gap for the integrated planar transformer.

12. The integrated planar transformer of claim 11, wherein:
the inductor segment comprises a first inductor post and a second inductor post;
the first side magnetic core structure is configured to form the first horizontally-aligned air gap for the integrated planar transformer between the first divider and the first side magnetic core structure;
the second side magnetic core structure is configured to form the second horizontally-aligned air gap for the integrated planar transformer between the second divider and the second side magnetic core structure;
the first divider is configured to form the third horizontally-aligned air gap between the first inductor post and the first divider; and
the second divider is configured to form the fourth horizontally-aligned air gap between the second inductor post and the second divider.

13. The integrated planar transformer of claim 9, further comprising:
a printed wiring board installed over the main magnetic core body, wherein the printed wiring board comprises at least two multi-layer primary winding PWBs.

14. The integrated planar transformer of claim 13, wherein the at least two multi-layer primary winding PWBs comprise:
a first primary winding PWB comprising a first layer and a second layer, wherein the first layer of the first primary winding PWB comprises a first winding from a positive high voltage post, through the inductor segment, and around the transformer segment, and wherein the second layer of the first primary winding PWB comprises the first winding unwinding around the transformer segment, passing through the inductor segment, and terminating at a middle voltage post; and
a second primary winding PWB comprising a first layer and a second layer, wherein the first layer of the second primary winding PWB comprises a second winding from the middle voltage post, through the inductor segment, and around the transformer segment, and wherein the second layer of the second primary winding PWB comprises the second winding unwinding around the transformer segment, passing through the inductor segment, and terminating at a negative high voltage post.

15. The integrated planar transformer of claim 9, wherein:
the main magnetic core body comprises ferrite;
the first side magnetic core structure comprises ferrite;
the second side magnetic core structure comprises ferrite;
the first side magnetic core structure is coupled to the left side of the inductor segment using a conductive epoxy; and
the second side magnetic core structure is coupled to the right side of the inductor segment using the conductive epoxy.

16. A method comprising:
coupling a first side magnetic core structure to a main magnetic core body for an integrated planar transformer to form a first horizontally-aligned air gap between the first side magnetic core structure and the main magnetic core body; and
coupling a second side magnetic core structure to the main magnetic core body for the integrated planar transformer to form a second horizontally-aligned air gap between the second side magnetic core structure and the main magnetic core body.

17. The method of claim 16, further comprising:
milling a core material to form the main magnetic core body for the integrated planar transformer;
milling the core material to form the first side magnetic core structure separately from the main magnetic core body; and
milling the core material to form the second side magnetic core structure separately from the main magnetic core body.

18. The method of claim 17, wherein the core material comprises ferrite.

19. The method of claim 16, further comprising:
coupling a first divider between the first side magnetic core structure and the main magnetic core body to form a third horizontally-aligned air gap between the main magnetic core body and the first divider, wherein the first horizontally-aligned air gap is located between the first divider and the first side magnetic core structure; and
coupling a second divider between the second side magnetic core structure and the main magnetic core body to form a fourth horizontally-aligned air gap between the main magnetic core body and the second divider, wherein the second horizontally-aligned air gap is located between the second divider and the second side magnetic core structure.

20. The method of claim 16, wherein:
coupling the first side magnetic core structure to the main magnetic core body comprises coupling the first side magnetic core structure to the main magnetic core body using a conductive epoxy; and
coupling the second side magnetic core structure to the main magnetic core body comprises coupling the second side magnetic core structure to the main magnetic core body using a conductive epoxy.
